(19) United States
(12) Patent Application Publication
(10) Pub. No.: US 2013/0227040 A1
(43) Pub. Date: Aug. 29, 2013

(54) METHOD AND SYSTEM FOR SENDING MESSAGES

(71) Applicant: CONCUR TECHNOLOGIES, INC., (US)

(72) Inventors: MICHAEL FREDERICKS, FAIRFAX, VA (US); MICHAEL LORE, VIENNA, VA (US); JONATHAN ALTMAN, BETHESDA, MD (US); KEITH MOFFATT, NEWCASTLE, WA (US); WILLIAM BRIAN WHITE, WASHINGTON, DC (US)

(73) Assignee: CONCUR TECHNOLOGIES, INC., REDMOND, WA (US)

(21) Appl. No.: 13/830,410

(22) Filed: Mar. 14, 2013

Related U.S. Application Data
(63) Continuation of application No. 13/712,629, filed on Dec. 12, 2012.
Application No. 13/712,629 is a continuation-in-part of application No. 13/602,589, filed on Sep. 4, 2012.
Application No. 13/602,589 is a continuation-in-part of application No. 13/593,108, filed on Aug. 23, 2012.
Application No. 13/602,589 is a continuation-in-part of application No. 13/277,923, filed on Oct. 20, 2011.
Application No. 13/602,589 is a continuation-in-part of application No. 13/277,916, filed on Oct. 20, 2011.
Application No. 13/602,589 is a continuation-in-part of application No. 12/901,947, filed on Oct. 11, 2010.
Application No. 13/602,589 is a continuation-in-part of application No. 12/773,282, filed on May 4, 2010.
Application No. 13/602,589 is a continuation-in-part of application No. 11/763,562, filed on Jun. 15, 2007.
Application No. 11/763,562 is a continuation of application No. 10/270,672, filed on Oct. 16, 2002, now abandoned.
Application No. 13/602,589 is a continuation-in-part of application No. 13/396,255, filed on Feb. 14, 2012.
Application No. 13/396,255 is a continuation-in-part of application No. 12/755,127, filed on Apr. 6, 2010, now Pat. No. 8,140,361.
Application No. 12/755,127 is a continuation of application No. 10/373,096, filed on Feb. 26, 2003, now Pat. No. 7,720,702.
Application No. 13/602,589 is a continuation-in-part of application No. 13/117,303, filed on May 27, 2011.
Application No. 13/117,303 is a continuation of application No. 11/159,398, filed on Jun. 23, 2005, now Pat. No. 7,974,892.
Application No. 11/159,398 is a continuation-in-part of application No. 13/606,494, filed on Sep. 7, 2012.
(60) Provisional application No. 61/569,942, filed on Dec. 13, 2011.
(60) Provisional application No. 61/569,949, filed on Dec. 13, 2011.
(60) Provisional application No. 61/569,942, filed on Dec. 13, 2011.
(60) Provisional application No. 61/569,949, filed on Dec. 13, 2011.
(60) Provisional application No. 61/529,680, filed on Aug. 31, 2011.
(60) Provisional application No. 61/405,480, filed on Oct. 21, 2010.
(60) Provisional application No. 61/405,488, filed on Oct. 21, 2010.
(60) Provisional application No. 61/405,480, filed on Oct. 21, 2010.
(60) Provisional application No. 61/405,488, filed on Oct. 21, 2010.
(60) Provisional application No. 61/324,533, filed on Apr. 15, 2010.
(60) Provisional application No. 61/324,533, filed on Apr. 15, 2010.
(60) Provisional application No. 60/329,281, filed on Oct. 16, 2001.
(60) Provisional application No. 60/581,766, filed on Jun. 23, 2004.
(60) Provisional application No. 61/705,265, filed on Sep. 25, 2012.

(51) Int. Cl. H04L 12/58

(52) U.S. Cl. CPC H04L 51/20
USPC 709/206

(57) ABSTRACT

A computer-implemented method and system of sending messages, comprising: performing processing for a person associated with receiving a request for location information for the person for an effective time; performing processing associated with receiving any travel information; performing processing associated with receiving any geolocation information: performing processing associated with receiving any expense information; performing processing associated with receiving any home or office location information; performing processing associated with receiving any current schedule/delay information for scheduled travel services; performing processing associated with determining a locations of the person using the travel information; performing processing associated with determining the location of the person using geolocation information, home/office information, expense information, or current schedule/delay information, or any combination thereof; performing processing associated with receiving information related to the location of the person using the travel information; and performing processing associated with sending a message to a device utilized by the person.

### CROSS-REFERENCE TO RELATED APPLICATIONS

This application is a continuation of U.S. patent application Ser. No. 13/713,629, filed Dec. 12, 2012, which in turn claims the benefit of U.S. Provisional Application Nos. 61/569,942, flied Dec. 13, 2011, 61/569,949, filed Dec. 13, 2011, and 61/705,265, filed Sep. 25, 2012. U.S. patent application Ser. No. 13/713,629 is also a Continuation-in-Part of U.S. patent application Ser. No. 13/606,494, filed Sep. 7, 2012. U.S. patent application Ser. No. 13/713,629 is also a Continuation-in-Part of U.S. patent application Ser. No. 13/602,589, filed Sep. 4, 2012, which claims the benefit of U.S. Provisional Application Nos. 61/569.942., filed Dec. 13, 2011 and 61/569,949, filed Dec. 13, 2011. U.S patent application Ser. No. 13/602,589 is a Continuation-in-Part of U.S. patent application Ser. No. 13/593,108. filed Aug. 23, 2012. which claims the benefit of U.S. Provisional Application No. 61/529,680, filed Aug. 31, 2011. U.S patent application Ser. No. 13/602,589 is also a Continuation-in-Part of U.S. patent application Ser. No. 13/277,923, filed Oct. 20, 2011, which claims the benefit of U.S. Provisional Application Nos. 61/405,480, tiled Oct. 21, 2010, and 61/405.488, filed Oct. 21, 2010. U.S patent application Ser. No. 13/602,589 is also a Continuation-in-Part of U.S. patent application Ser. No. 13/277,916, filed Oct. 20, 2011, which claims the benefit of U.S. Provisional Application Nos. 61/405,480, filed Oct. 21, 2010, and 61/405,488, filed Oct. 21, 2010. U.S patent application Ser. No. 13/602,589 is also a Continuation-in-Part of U.S. patent application Ser. No. 12/901,947, tiled Oct. 11, 2010, which claims the benefit of U.S. Provisional Application No. 61/324,533. filed Apr. 15, 2010. U.S patent application Ser. No. 13/602,589 is also a Continuation-in-Part of U.S. patent application Ser. No. 12/773,282, filed May 4, 2010, which claims the benefit of U.S. Provisional Application No. 61/324,533, filed Apr. 15, 2010. U.S patent application Ser. No. 13/602,589 is also a Continuation-in-Part of U.S. patent application Ser. No. 11/763,562, filed Jun. 15, 2007, which, in turn, is a Continuation of U.S. patent application Ser. No. 10/270,672, filed Oct. 16, 2002 (now abandoned), which, in turn, claims the benefit of U.S. Provisional Application No. 60/329,281, filed Oct. 16, 2001. U.S patent application Ser. No. 13/602,589 is also a Continuation-in-Part of U.S. patent application Ser. No. 13/396,255, filed Feb. 14, 2012, which, in turn, is a Continuation of U.S. patent application Ser. No. 12/755,127, filed Apr. 6, 2010 (now U.S. Pat. No. 8,140,361), which, in turn, is a Continuation of U.S. patent application Ser. No. 10/373,096, filed Feb. 26, 2003 (now U.S. Pat. No. 7,720,702) U.S patent application Ser. No. 13/602,589 is also a Continuation-in-Part of U.S. patent application Ser. No. 13/117,303, filed May 27, 2011, which, in turn, is a Continuation of U.S. patent application Ser. No. 11/159,398, filed Jun. 23, 2005 (now U.S. Pat. No. 7,974,892), which, in turn, claims the benefit of U.S. Provisional Application No. 60/581,766, filed Jun. 23, 2004. All of the foregoing are incorporated by reference in their entireties for all purposes.

This application is also related to U.S. patent application Ser. No. 11/774,489, filed Jul. 6, 2007 (now abandoned), which is incorporated by reference in its entirety for all purposes.

### BRIEF DESCRIPTION OF THE FIGURES

FIG. 1 illustrates a system for identifying candidate users and sending messages, according to an embodiment of the invention.

FIG. 2 is a system diagram illustrating interaction management application of FIG. 1, according to an embodiment of the invention.

FIG. 3 sets forth a method for sending messages, according to an embodiment of the invention.

### DETAILED DESCRIPTION OF EMBODIMENTS OF THE INVENTION

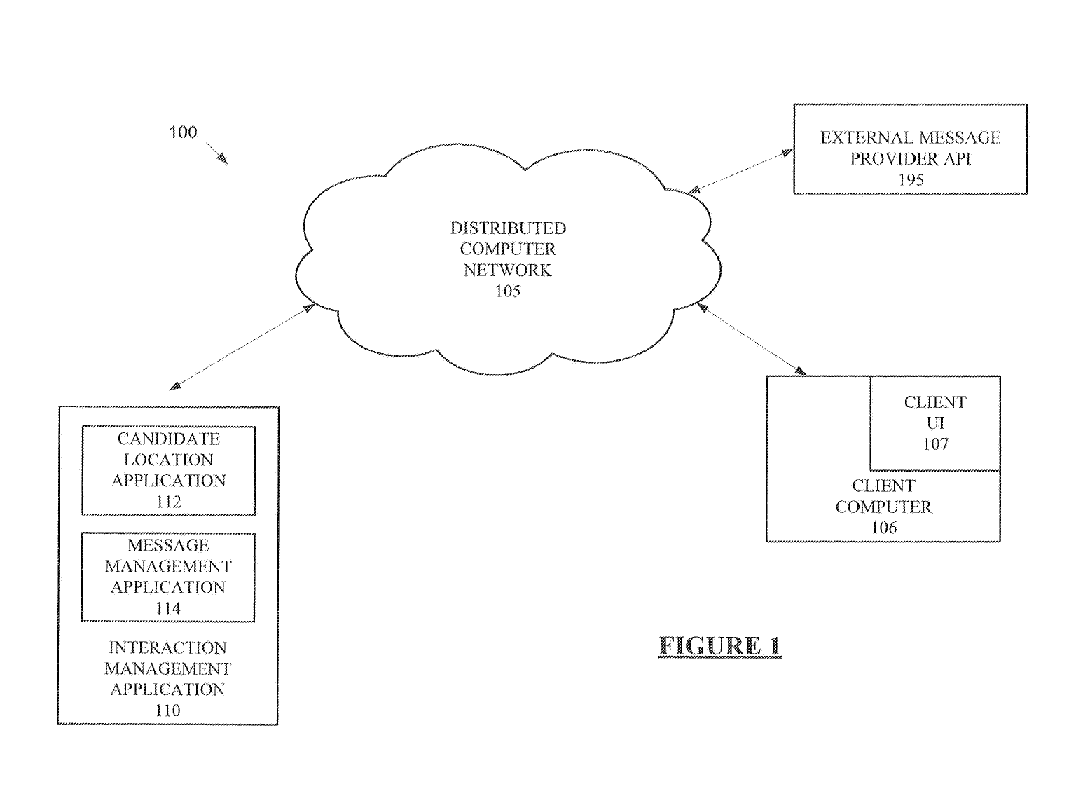

FIG. 1 illustrates a system 100 for sending messages, according to one embodiment. Using an environment such as the one illustrated in FIG. 1, messages targeted to a particular user can be sent. In one embodiment, travelers can be sent targeted messages (e.g., from a host) while they utilize applications and/or devices (e.g., personal digital assistant, phone, smart phone, etc.) when they travel using, in some embodiments, an effective time. The effective time can be: a time in the past, a time in the future, or a time in the present, or any combination thereof.

These devices and/or applications can also include features that provide weather information, flight information (e.g., status, schedule, gate, and baggage information), travel reservation and/or itinerary information (e.g., for air, rail, hotel, car, limousine, taxi, dining, or airport parking), geolocation information obtained from global positioning system (UPS) or IP address location information (e.g., to help target messages), or any combination thereof. Those of ordinary skill in the art will see that many other features can be included. In addition, some devices and/or applications can integrate with other devices and/or applications so that information can be exchanged to improve the experience. Although the example of users that are travelers is utilized throughout this application, it should be noted that any users (e.g., users that are currently traveling, users that are not currently traveling) may utilize system 100.

One example of system 100 is set forth in FIG. 1. However, it should be noted that system 100 could include: a traditional web-based application inside a computer browser. a client-server application which runs on a local personal computer, a mobile web application which is optimized for a smart phone or PDA, a system that involves sending email, text or other short messages to a device (e.g., phone computer), or a mobile application that runs as a program on a smart phone. PDA, iPad, or other mobile computing device; or any combination thereof

FIG. 1 illustrates some primary components of system 100, according to an embodiment of the present invention. System 100 can comprise: a distributed computer network 105; a client computer 106; a client user interface (UI) module 107: or an interaction management application 110 (e.g., comprising, in one embodiment, a candidate location application 112; or a message management application 114; or both) in communication with a host server computer 120; or any combination thereof. It should be noted that many configurations are possible. For example, the interaction management application 110 can be accessed from the work stations 106, which can communicate with the host server computer 120. In addition, the interaction management application 110 can be wholly or partially located on the client work station 106. Further, the interaction management application 110 can communicate with the candidate location application 112 and the message management application 114. Additionally, the interaction management application 110 can be wholly or partially located on the host server computer 120; the candidate location application 112 can be wholly or partially located on the host server computer 120; or the message management application 114 can also be wholly or partially located on the host server computer 120; or any combination thereof. Those of ordinary skill in the art will see that other configurations are also possible. It should be noted that any of the modules, applications, systems, steps etc. of FIGS. 1-3 can be optional, or can be fully or partially combined with other modules/applications, systems, etc.

Referring back to FIG. 1, the distributed computer network 105 can be a network (e.g., Internet, Intranet) that facilitates communication between one or more client computers 106, such as but not limited to personal computers (PCs), minicomputers, microcomputers, main frame computers, telephone devices, or other wired or wireless devices, such as hand-held devices, or any combination thereof FIG. 1 also illustrates a interaction management application 110, which is housed, for example, on a host server computer 120, which can include, but is not limited to: a minicomputer, a microcomputer, a PC, a mainframe computer, or any device with a processor and repository (e.g., database) or coupling to a repository, or any combination thereof. The client computer 106 can accept input from users, and allow users to view output from the interaction management application 110. The client computer could be, for example, a PC-based workstation, mobile computing device (e.g. iPad or Android-based tablet), or internet-cormected cellular network device (e.g. internet-capable cell phone, iPhone, or other device). The client U1 module 107 can include software on the client computer 106 that can let a user view, for example, HyperText Markup Language (HTML) documents and access files and software related to those documents. The present invention can utilize, for example, HTML-based systems, Java-based systems, XML-based systems, or systems where a custom-built application communicates over the network, or any combination thereof. Those of ordinary skill in the art will see that many other types of systems can be utilized.

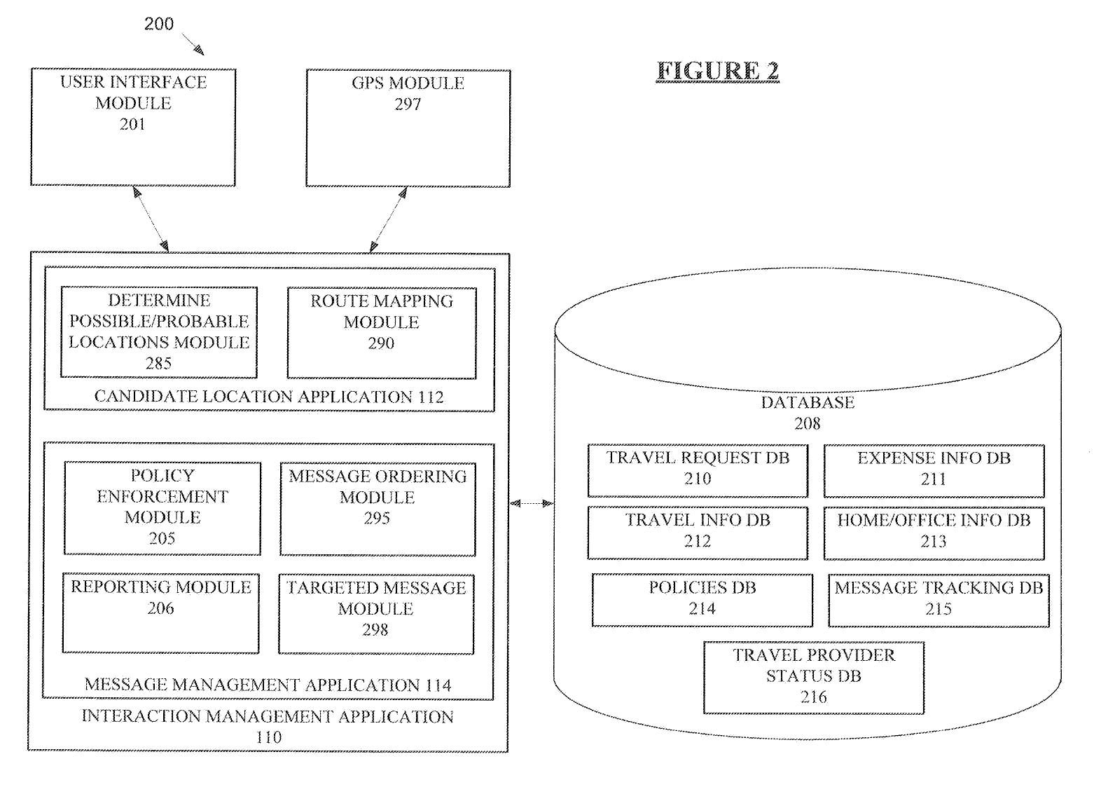

The interaction management application 110 can work on or with a client U1 module 107 to display information to the user so that services and/or products can be booked and/or expensed. Some details of the interaction management application 110 are set out in FIG. 2. The interaction management application 110 can work with many other types of tools (e.g., global distribution system, service provider website such as, but not limited to, an airline or car rental website, or internal database, or any combination thereof). For example, interaction management application 110 can retrieve messages from an external message provider application programming interface (API) 195 (e.g., Serve, Savored) and then send those messages to users. In other embodiments, messages may be retrieved from an internal database and/or input by an administrator and/or manager and sent to users.

FIG. 2 is a system diagram illustrating interaction management application 110 of FIG. 1, according to one embodiment of the present invention. The interaction management application 110 can comprise a candidate location application 112, a message management application 114, a server U1 module 201, a database 208, or a targeted messages module 298, or any combination thereof. While these various modules are explained with respect to the interaction management application 110, those of ordinary skill in the art will see that not all modules described are necessary. In addition, additional modules or combination modules are possible. Additionally, it should be noted that pieces of modules can be utilized with or without other modules.

In one embodiment, the interaction management application 110 can include a server module 201, which can communicate with a client module 107 (e.g., on a client work station 106) through the network 105. The server module 201 can transmit data to the client module 107 (e.g., corporate policy data, data accumulated from various travel and expense data sources including itinerary information, geolocation information, or home/office information, or any combination thereof). Those experienced in the art will recognize that many other modules can be used to build the interaction management application 110.

Data found and utilized by the interaction management application 110 can be stored in database 208. In one embodiment, the database 208 can comprise a travel request (e.g., itinerary, reservation) database 210, an expense information database 211, home/office information database 213, cached travel provider status updates (e.g. flight schedules, flight delay information) database 216 a message tracking database 215, a policies database 214, or a travel information database 212, or any combination thereof.

The travel request database 210 can comprise data received by using some combination of multiple sources (e.g., an on-line booking tool, a travel agent, communication with a travel vendor reservation and/or sale system or provider ancillary option system). The travel request data from these sources can be assembled and stored in the travel request database 210.

The expense information database 211 can comprise expense data received from multiple sources as well. The payer (e.g., the user, the traveler, the traveler's assistant), can pay the travel agency or travel vendor with, for example, a credit card. The record of this transaction can go to the credit card vendor, which can transmit funds to the travel vendor for the amount purchased. The expense information database 211 could be used in the following example: after travel occurs, and a user goes to submit an expense report, or credit card information is received from a credit card vendor, this infonuation can be used to help determine the location of the user.

The policy database 214 can comprise data relating to various entities policies. Information from the policy database 214 can be used by the policy enforcement module 205 to review targeted messages (e.g., offers) to make sure they comply with entity policies. Information from the policy database 214 can also be used by the message ordering module 295 to prioritize messages based on whether they comply with the entities' policies. For example, the policy database 214 may be utilized to mandate that messages relating to emergency situations (e.g., weather, terrorist attacks, dangerous situation, problematic situation) are to be sent to all users with travel information that includes a location where an emergency situation exists. In another embodiment, the policy database 214 may be utilized to mandate that messages relating to emergency situations are to be sent to all users with travel information that includes a location where an emergency situation exists unless there is geolocation data or other data (e.g., credit card data, expense report data) that indicates the user is not in that location.

The message tracking database 215 can comprise data relating to how the user or someone associated with the user, such as an assistant, colleague, family member, etc.) interacted with the message. For example, the message tracking database 215 inay store data indicating that certain users sent back messages saying they were OK, while other users sent back messages indicating they needed help, while other users did not respond to the message.

The travel information database 212 can comprise data relating to past, present, and future booked travel associated with a user that can originate from multiple sources; for example an on-line booking tool, a travel global distribution system, a travel provider's (e.g., airline, rail system, hotel chain, car rental company) reservation system. data received from a travel agency system or input by a travel agent via client UI application 107, data input by the traveler via client UI application 107, or sent by the traveler via email. Those of ordinary skill in the art will see that these are only examples of the sources and that many other sources may be included.

The home/office information database 213 can comprise infbrmation about a user's home residence address and normal work locations, and also information about other office locations that a user's employer may have, received from some combination of employer human resources (HR) or Enterprise Resource Planning (ERP) or other systems, or input by the employer or user via client UI application 107. The home/office information database 213 can be used in the following example: when a message needs to be sent out to all users in a location where an emergency situation exists, the information in the database can be used to identify any additional possible locations of users who are indicated as having a home or office location near the emergency situation.

The travel provider status database 216 can comprise information about scheduled transportation service (e.g. airline flights, rail train schedules, bus schedules) containing origin and destination information for the transportation, including location and scheduled times. Information can be provided by data feeds either from data aggregators who provide information on a variety of travel vendors, directly from the travel vendors, or as identified when travel information is updated in travel information database 212. Those of ordinary skill in the art will see that these are only examples of the sources and that many other sources may be included. Multiple updates for any particular scheduled transportation service may be received from multiple sources, updating the current expected or actual arrival and departure information. The information in this database can be used as one of the sources to determine possible locations of users in combination with information from travel information database 212. For example, if an emergency situation (e.g., a hurricane in southern Florida) is identified in a particular location, all travelers who may be arriving at that destination can be identified and the current status of their transportation retrieved from travel provider status database 216 to determine if the users have arrived in the location of the emergency situation or have been delayed, rerouted, or had their transport cancelled. Those of ordinary skill in the art will see that this is only one example of the ways in which transport schedule updates can be used in this embodiment.

Those of ordinary skill in the art will see that the various databases can be combined or broken up further in some embodiments of the invention.

The candidate location application 112 can receive travel data from a travel system, expense transaction data from a credit card vendor, and purchasing data from a travel vendor. For a given expense, data may be present from any number of sources, including the possibility that no data is present. The candidate location application 112 can receive data from the multiple sources at different times and different rates. A source could transmit data continuously or near-continuously (e.g., once per hour), daily, weekly, monthly or at longer intervals. The candidate location application 112 can store all the data received from all the sources when the information is received into the various databases comprising database 208. The candidate location application 112 can identify the traveler corresponding to a given travel request and/or expense data and/or using an affinity program number (e.g., frequent flier number). Expense data can come encoded with a credit card number that has been assigned to a specific person. For example, for central billed cards, other traveler-identifying information can be included. in an alternate embodiment, if a user uses an on-line self-booking tool to make a travel request, an identification of the user making the request (or user on whose behalf the request is made) can be stored at the time of request, and the record locator from the PNR can also be stored. Travel data identified by this specific record locator can be mapped to a specific traveler. Information about a traveler can be embedded into the remarks section of the PNR by the travel agency, or the passenger's name can be read from the PNR. Similar methods can be used to identify the traveler on data transmitted directly from a travel vendor. Additionally other uniquely identifying information, such as frequent traveler numbers, can be used.

As indicated above, the candidate location application 112 can comprise: a determine possible/probable locations module 285, or route mapping module 290, or both.

The route mapping module 290 can use information from the various databases, as well as information from the geolocation module 297, to map a traveler's route for a particular time period. This routing information may be useful in determining where a user is and whether the user is at or near a certain location.

The determine possible/probable locations module 285 can use information from the various databases, as well as information from the geolocation module 297 and route mapping module 290, to identify a set of possible locations that a particular person may be in, or to identify all users who may possibly be in a particular location. Each possibility can then be enhanced to include the probability based on heuristics regarding the source of the information placing a user at a possible location.

For example, in some embodiments, the possible/probable locations module 285 can retrieve the list of all trips scheduled to take place on or around a particular date from the travel request database 210, including the itineraries of the traveler and information about what airline or rail tickets have been issued. It can additionally retrieve expense information from the expense information database 211 to find expense information already received, for example credit card charges or user-submitted charges, related to travel during the particular date. Where expense information can be positively or potentially matched to itinerary information retrieved from travel request database 210, the probability that a traveler will be in the locations identified by the itinerary on a particular time and date can be calculated as higher than an alternate itinerary for the traveler that shows as being booked at around the same time. Separately, when the particular date being searched for probable locations is close to the current date and time, then additional weighting could be given to trips booked within a very short time (e.g. 48 hours or less) from the present—regardless of whether, for example, an airline ticket has been found in the travel request database 210 or a credit card charge has been found in expense information database 211—versus an older trip that had an airline ticket based on the likelihood that a newer trip booked close to travel might indicate a change in plans.

Further, travelers past travel patterns can be analyzed in the travel request database 210, along with previous responses in the message tracking database 215 to determine whether travelers tend to stick with established trips, or ended up making last minute changes, and probabilities adjusted according to their observed behavior, along with observations of the tendencies of other travelers who have information in the travel request database 210 and whose past travel patterns are identified as similar based on statistical correlations.

The determine possible/probable locations module 285 can also provide users (e.g., administrators and/or employees of an entity) to specify, using the user interface module 201, various weightings that should be applied to the various data points. In the case that there is no information in the travel information database 212 for where the user is at a particular time, or the travel information database shows the user as being away from any home/office location information in the home/office information database 213, determine possible/probable locations module 285 can also adjust the probability upwards that the user is located at the home or office locations found for them in the home/office. information database 213.

The message management application 114 can be invoked by the user interface module 201 to send targeted messaging to any user identified as being in a candidate location by the determine possible/probably location module 285 of candidate location application 112.

The message management application 114 can also comprise: a policy enforcement module 205, a message ordering module 295, a reporting module 206, or a targeted message module 298, or any combination thereof

The policy enforcement module 205 can review, for example, various messages to make sure they comply with entity policy before sending or making available any messages to a user. The policy enforcement module 205 can also be used with the message ordering module 295 to show or send messages in a particular order.

The reporting module 206 can be used to process responses to targeted messages sent out by the message management application 114 received through multiple sources, for example the client UI 107, phone call, SMS or email responses. Based on the responses, the various databases can be updated with for example information on a user's location, whether they need help as the result of being in an emergency situation, or whether an offer presented to them was viewed or redeemed. Those of ordinary skill in the art will see that these are only examples of the ways in which responses can be received and processed.

The targeted message module 298 can be used to identify messages from, for example, the external message provider API 195 that could be sent to a user and used to identify, based on the user's possible or probable location, heuristics about the user's preference for receiving a particular message based on their previous travel and expense data history in the various databases, or the similarity of that data to other user's data in the system. Those of ordinary skill in the art will see that these are only examples of the ways in which the module can determine what messages to target to a particular user.

The message ordering module 295 can be used to take a set of candidate messages to be sent to a user by the message management application 114 and order them according to various priorities. For example, messages relating to determining the status of users located at a location affected by an emergency situation could take priority over any other messages for those users, or for the entire system, or the order may be determined based on policies determined by the policy enforcement module 205 or targeted message module 298. Those of ordinary skill in the art will see that these are only examples of the ways in which messages may be ordered by the message ordering module 295.

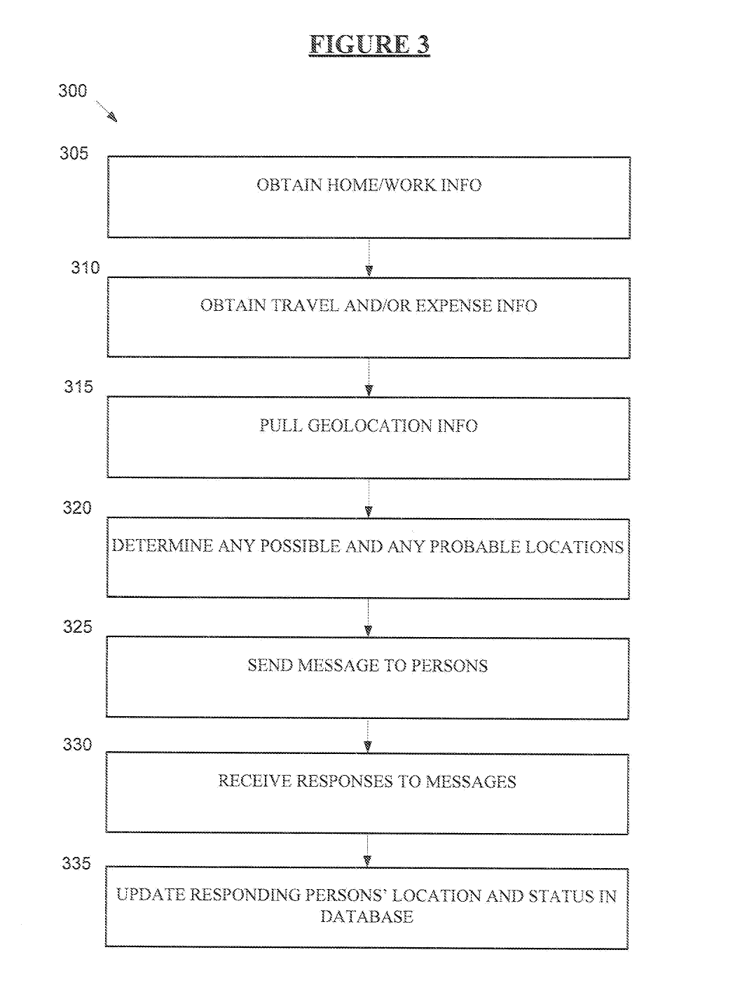

FIG. 3 illustrates a method 300 of sending messages to users, according to an embodiment. This method may utilize home and/or work information. geolocation information, and all known itinerary and/or expense information. This method takes into account that some users transmit GPS or other geolocation data infrequently (e.g., due to privacy concerns, due to being in remote areas). This method also takes into account that travel reservation and/or expense data can be complex. For example, a person may reserve or book two flights that depart on the same day to different locations. In this way, a person may postpone the decision of which meeting or event to attend until the last possible moment, and either cancel the reservation or obtain a refund for the ticket not used. As another example. if a person books a one-way ticket, there is no knowledge in that itinerary as to when, or if, the person plans to return home. Furthermore, there may be multiple sources of travel and/or expense data for a given individual. A person may book corporate travel through a process defined by her company, and personal travel on-line directly with suppliers. That same person may decide not to follow the official corporate travel policy for a given trip and book a corporate trip outside the official channel. That person may also use an itinerary management tool (e.g., Tripit®) to aggregate her itineraries. Even if travel information Database 212 has access to all of the itineraries for an individual from multiple sources, it can be challenging to determine the most likely location of a traveler. Similarly, expense information may come from at least one credit card vendor, travel vendor, or expense report, or any combination thereof

It may be useful to send messages to users based on an educated guess of any possible locations of persons using geolocation information, travel and/or expense information, or home and/or work information, or any combination thereof For example, in 2011 there were riots in the London, England region, a tsunami and earthquake in Japan, and Hurricanes that struck the East Coast of the United States. When an unplanned event occurs, the knowledge of which persons are in the region of the event can be of great value to an entity (e.g., government, non-profit, corporation, etc.) and the ability to message those persons in real-time can also be valuable. Some events are predictable in nature. For example if a labor group announces a strike in a certain city for a period three days in the future, knowing who would be in that city on that day would be valuable.

Referring to FIGS. 3, in 305, known home and/or work information may be obtained. In this way, if a person's travel and/or expense data indicates that the person is not travelin_{g} (e.g., there is no current travel and/or expense data; the travel and/or expense data indicates a user returned from a trip yesterday or leaves in three days), it may be determined that the person is at home or work. For example, the home and/or office database 213 may store all known home and/or work contact information (e.g., phone numbers, fax numbers, email addresses, physical addresses, etc.) This home and/or work information may also be retrieved from an entity via an electronic file feed, or manually entered via a web site, etc.

In 310, all known travel and/or expense data may be obtained. For example, all the data from a plurality of travel reservation sources (e.g., via the traveler e-mailing an itinerary to a service, fetching itineraries from one ore more travel reservation systems, obtaining data transmitted directly from a travel agency or travel supplier, etc.) may be taken and the multiple itineraries may be aggregated into the travel reservation database 212. Similarly, all expense data from a plurality of sources (e.g., credit card vendor, travel vendor, expense report, etc.) may be aggregated into the expense information database 211.

In 315, all geolocation data from the person's device(s) may be obtained.

In 320, the determine possible and probable locations module 296 may determine any possible locations for the person, and weed out the possible locations using geolocation data and/or expense data, or details related to the itinerary data, to determine probable locations. In one embodiment, travel data from the plurality of travel reservation sources may be aggregated. and any possible location(s) where the travel reservations indicate a person may be on a given day may be utilized. If there are multiple locations, then it may be determined if there is one most likely location that is sufficiently more likely than all others to be the location where the employee is traveling. For example, if it was found that a person had two conflicting itineraries, one which would place the person in Atlanta and another that would place the person in Chicago, geolocation data (e.g., from a phone, computer, etc), and/or expense data (e.g., credit card information, etc.) may indicate that the person is in Atlanta. Thus. Atlanta would be the only probable location.

In one embodiment, a function based on attributes of each itinerary may be utilized to determine any probable locations. The attributes may comprise: a source of the itinerary, a time the itinerary information was received; similarity to past travel of the person; similarity to past travel of other persons who have similar travel patterns to the person; or the feasibility of the itinerary being accurate; or any combination thereof As an example, a traveler may have two itineraries with flights taking them to two different places on the same day; the system could determine that only one of the two itineraries' flights has issued tickets shown in the itinerary data. The itinerary with the issued tickets may be scored higher than the itinerary without issued tickets, if the purchase of tickets provides a stronger indicator that the user is likely to fly that particular itinerary's flights.

In some embodiments, route mapping information from the route mapping module 290 may be used to further determine possible and/or probably locations.

In some embodiments, if multiple conflicting itineraries have been received, weighting could be given to itineraries based on when they were generated. This could be done because more recent itineraries are more likely to be current. However, that is not always the case, as sometimes the date of receipt of the itinerary does not match the date the itinerary was booked, and sometimes newer itineraries are booked in error by someone not remembering that a previous trip already exists. Even when GPS or IP address geolocation data is received via geolocation module 297 it can be treated as current location, but there is no guarantee how long the person will stay in that general vicinity. People can be asked on, for example, a smartphone, how long they plan to stay in a location but that information may or may not be accurate as it may be mis-entered or plans may change. For example. the geolocation information may be obtained when the person checks in and indicates his or her location and/or how long the person expects to stay at that location.

The policies database 214 can store information about entity policies and what message policies should be in place. The policy enforcement module 205 can make sure the policies are enforced. For example, if it is determined that there are multiple possible locations for a person, a company's policy may dictate that the company should send a message regarding an emergency or otherwise problematic situation to everyone that could possibly be at that location. Additionally, a company's policy may dictate that if there is UPS data indicating that a person is not in the emergency/problematic location, that the message should not be sent.

If there is more than one probable location for a person, or if an entity's policy dictates that if it is possible that a person is in more than one location (e.g., even if there is data such as GPS or other geolocation data or credit card data indicating the person is not in that location), then the interaction management application 110 may act as though the person were in multiple locations at a given time for the purpose of messaging, until more definitive and/or acceptable (e.g., under the entity's policies) information is received.

In 325, messages may be sent to persons based on any possible locations of the persons.

For example, assume an executive booked two trips on Friday March 5^{th}, each of which departs on Tuesday March 9^{th}. One of the trips departs from Boise, Id. to Charlottesville, Va. at 2 PM, and the other departs from Boise, Id. to Fargo, N.D. at 3 PM. Each trip has a return date of Thursday, March 11^{th}. The executive booked these two trips because there were meetings in each city, and the executive had not yet decided which meeting to attend. As a relatively short time remained before departure, there was a risk of not being able to obtain a seat should the executive wait until her meeting plans firmed up to book the travel. On Wednesday March 10^{th}, an earthquake occurs near Charlottesville, Va.. The candidate location application 112 may be used to determine which employees are near Charlottesville. The system 100 may not know for certain that the executive is in Charlottesville, for she may be in Fargo. However, sending her a notice about the earthquake and inquiring whether she is ok would likely not be seen as a significant problem if she were in Fargo instead of Charlottesville. If instead, on March 9^{th}, the system received via geolocation module 297 data showing that the executive was in Fargo, the system 112 may discard the Charlottesville reservation and thus not sent out the notification of the earthouake.

In 330, when interaction management application 110 identifies the location of persons and messages them via message management application 114, it may be useful for interaction management application 110 to have a tool that receives responses from the persons and aggregates them. For example, the entity may send a SMS or Email message to persons and ask them to respond if they are ok or if they need help. The reporting module 206 may then parse the responses, update the message tracking database 215, and provide to the entity a list of persons who are ok, a list of persons who need help, and a list of persons who have not responded.

Based on the responses received, in 335, interaction management application 110 can also send updates to candidate location application 112 indicating that a user has identified themselves as either being at or not at potential candidate locations identified in 320, and, in 335, update the appropriate databases in 208.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown. For example, the steps listed in any flowchart may be re-ordered or only optionally used (even when not explicitly indicated) in some embodiments. Thus, those skilled in the art will realize that the ordering of the steps of the figures can be altered in other embodiments and that various steps can be removed in some embodiments.

It should also be noted that when the term “a”, “an”, etc. is used. it is to be interpreted as “at least one” throughout the application and claims. In addition, the term “comprising”, used throughout the application (e.g., claims, specification, drawings) signifies “including, but not limited to”.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer-implemented method of sending messages, comprising:
performing processing associated with receiving a request for location information for a person for an effective time;
performing processing associated with receiving any travel information relating to the person from a plurality of sources;
performing processing associated with receiving any geolocation information relating to the person;
performing processing associated with receiving any expense information related to the person;
performing processing associated with receiving any home or office location information related to the person from a plurality of sources;
performing processing associated with receiving any current schedule/delay information for scheduled travel services
performing processing associated with determining any possible locations of the person using the travel information;
performing processing associated with determining any probable locations of the person using the any possible locations, geolocation information, home/office information, expense information, or current schedule/delay information, or any combination thereof;
performing processing associated with receiving information related to probable locations of the person using the travel information; and
performing processing associated with sending a message to a device utilized by the person at any probable locations.

2. The method of claim 1, further comprising:
performing processing associated with sending a message to the device utilized by the person at more than one probable location.

3. The method of claim 1, wherein information related to the person's probable locations is displayed via a computerized interface.

4. The method of claim 3, wherein the computerized interface comprises: a map-based display on a computer monitor; a map-based display on a portable device; or a web service where the data is presented to an external computerized system, or any combination thereof.

5. The method of claim 1, wherein the message may be transmitted utilizing: electronic mail; SMS text messaging; a telephone; or a direct message via a public social media service; or any combination thereof.

6. The method of claim 1, wherein the person receiving the message may respond to the message indicating: which of the probable locations the person is at, the person is at none of the probable locations; or the person is at an alternative location; or any combination thereof

7. The method of claim 6, wherein a computer-implemented method receives the person's response and returns information about the person's current location.

8. The method of claim 1, wherein the location of the person is determined and/or guessed given multiple location options.

9. The method of claim 1, wherein multiple sources are utilized to find the location of the person.

10. The method of claim 1, wherein the person is treated as being in at least two places at one time.

11. The method of claim 1, wherein a user is able to access reporting information showing who is in what location.

12. The method of claim 11, wherein the user is able to query an application for information about possible and/or probably locations of the person.

13. The method of claim 1, wherein the location of the person is determined and/or guessed regardless of whether the person is traveling.

14. A computer-implemented system of sending messages, comprising:
at least one processor configured for:
performing processing associated with receiving a request for location information for a person for an effective time;
performing processing associated with receiving any travel information relating to the person from a plurality of sources;
performing processing associated with receiving any geolocation information relating to the person;
performing processing associated with receiving any expense information related to the person;
performing processing associated with receiving any home or office location information related to the person from a plurality of sources;
performing processing associated with receiving any current schedule/delay information for scheduled travel services ;
performing processing associated with determining any possible locations of the person using the travel information;
performing processing associated with determining any probable locations of the person using the any possible locations, geolocation information, home/office information, expense information, or current schedule/delay information, or any combination thereof;
performing processing associated with receiving information related to probable locations of the person using the travel information; and
performing processing associated with sending a message to a device utilized by the person at any probable locations.

15. The system of claim 14, further comprising:
performing processing associated with sending a message to the device utilized by the person at more than one probable location.

16. The system of claim 14, wherein information related to the person's probable locations is displayed via a computerized interface.

17. The system of claim 16, wherein the computerized interface comprises: a map-based display on a computer monitor; a map-based display on a portable device; or a web service where the data is presented to an external computerized system, or any combination thereof.

18. The system of claim 14, wherein the message may be transmitted utilizing:
electronic mail; SMS text messaging; a telephone; or a direct message via a public social media service; or any combination thereof.

19. The system of claim 14, wherein the person receiving the message may respond to the message indicating: which of the probable locations the person is at, the person is at none of the probable locations: or the person is at an alternative location; or any combination thereof.

20. The system of claim 19, wherein a computer-implemented method receives the person's response and returns information about the person's current location.

21. The system of claim 14, wherein the location of the person is determined and/or guessed given multiple location options.

22. The system of claim 14, wherein multiple sources are utilized to find the location of the person.

23. The system of claim 14, wherein the person is treated as being in at least two places at one time.

24. The system of claim 14, wherein a user is able to access reporting information showing who is in what location.

25. The system of claim 24, wherein the user is able to query an application for information about possible and/or probably locations of the person.

26. The system of claim 14, wherein the location of the person is determined and/or guessed regardless of whether the person is traveling.
